(19) United States
(12) Patent Application Publication
(10) Pub. No.: US 2026/0124882 A1
(43) Pub. Date: May 7, 2026

(54) HEAT MANAGEMENT SYSTEM FOR VEHICLE AND METHOD FOR CONTROLLING THE SAME

(71) Applicants: Hyundai Motor Company, Seoul (KR); Kia Corporation, Seoul (KR)

(72) Inventors: Qing Dong HOU, Yantai (CN); Tae Hun Jung, Hwaseong-si (KR); Xiaorui Zhai, Yantai (CN)

(73) Assignees: Hyundai Motor Company, Seoul (KR); Kia Corporation, Seoul (KR)

(21) Appl. No.: 19/381,493

(22) Filed: Nov. 6, 2025

(30) Foreign Application Priority Data
Nov. 7, 2024 (CN) 202411585405.6

(51) Int. Cl. B60H 1/32; B60H 1/00

(52) U.S. Cl. CPC B60H 1/3216; B60H 1/00278; B60H 2001/3266; B60H 2001/3267

(57) ABSTRACT

In a heat management system for a vehicle, and a control method thereof, the control method includes: determining whether a delayed operation condition of a compressor is satisfied while the compressor is not operated; controlling an operation of the compressor to be delayed based on the determining that the delayed operation condition of the compressor is satisfied; determining whether a battery cooling condition is satisfied based on the determining that the delayed operation condition of the compressor is not satisfied; and controlling the compressor to be operated based on the determining that the battery cooling condition is satisfied.

### CROSS-REFERENCE TO RELATED APPLICATION

The present application claims priority to and the benefit of Chinese Patent Application No. 202411585405.6 filed with the Chinese National Intellectual Property Administration on November 7, 2024, the entire contents of which are incorporated herein by reference.

### BACKGROUND OF THE PRESENT DISCLOSURE

### Field of the Present Disclosure

The present disclosure relates to a heat management system for a vehicle and a control method thereof, and more particularly, the present disclosure relates to a heat management system for a vehicle for improving the internal cooling function of a vehicle while ensuring a battery cooling function of an electric vehicle, and a control method thereof.

### Description of Related Art

In electric vehicles, a high voltage battery is installed as a power source. To keep the high-voltage battery of the vehicle at its optimal operating temperature, a battery chiller is installed in the battery cooling device of the electric vehicle. The battery chiller of the battery cooling device and an evaporator of an air conditioning device are installed in parallel so that the battery chiller may cool a coolant according to heat-exchange between the coolant of the battery cooling device and refrigerant supplied from the air conditioning device, thereby cooling the high-voltage battery using the cooled coolant.

An expansion valve for expanding the refrigerant is respectively installed on an upstream portion of the battery chiller and the evaporator. The expansion valve installed on the upstream portion of the battery chiller is an electronic expansion valve precisely controlling the opening of the valve, and to reduce costs, the expansion valve installed on the upstream portion of the evaporator is a mechanical expansion valve generally having two states: opened and closed. In a battery cooling mode, when a user opens an A/C switch of the air conditioning device, the mechanical expansion valve installed on the upstream portion of the evaporator is opened. When the mechanical expansion valve is opened, large noise is generated due to a refrigerant pressure difference between the upstream portion and the downstream portion of the mechanical expansion valve. To prevent loud noise from being generated, conventional air conditioning devices stop operation of the compressor for a predetermined time period, open the mechanical expansion valve, and allow the compressor to resume operation. When the compressor stops operating, it is detrimental to both battery cooling and vehicle interior cooling. Hence, it is necessary to avoid the compressor from stopping operation as much as possible, or if it is impossible to avoid stopping of the operation of the compressor, the duration of stopping of the operation of the compressor must be reduced as much as possible.

The above information disclosed in this Background section is only for enhancement of understanding of the background of the present disclosure, and therefore it may contain information that does not form the related art that is already known in this country to a person of ordinary skill in the art.

### BRIEF SUMMARY

Various aspects of the present disclosure attempt to solve the problems of the related art, and the description below in the specification clarifies other technical issues not addressed in the text by the ordinary skilled person.

According to various aspects of the present disclosure, it is directed to providing a heat management system for a vehicle and a control method thereof that may improve the internal cooling function of a vehicle while ensuring the battery cooling function of an electric vehicle.

According to various aspects of the present disclosure, the present disclosure provides a heat management system for a vehicle including: an evaporator disposed in an air conditioning device; an expansion valve disposed on an upstream of the evaporator; a battery chiller disposed in parallel with the evaporator, cooling a coolant by heat-exchange between the coolant and a refrigerant supplied from the air conditioning device, and cooling a battery using the cooled coolant; a compressor compressing the refrigerant; and a controller, wherein the controller is configured to: determine whether a delayed operation condition of the compressor is satisfied while the compressor is not operated, control the compressor to delay operation thereof based on the determining that the delayed operation condition of the compressor is satisfied, determine whether a battery cooling condition is satisfied based on the determining that the delayed operation condition of the compressor is not satisfied, and control the compressor to be operated based on the determining that the battery cooling condition is satisfied.

According to various aspects of the present disclosure, the controller may be further configured to: determine whether an A/C switch of an air conditioning device is in an opened state while the compressor is operated, and control the compressor to stop the operation based on the A/C switch of the air conditioning device being in the opened state.

According to various aspects of the present disclosure, the controller may be further configured to: determine whether the compressor satisfies an operation restoring condition while the compressor has stopped the operation, and open the expansion valve and control the compressor to restore the operation based on that the compressor satisfies the operation restoring condition.

According to various aspects of the present disclosure, the controller may be further configured to: determine whether the delayed operation condition of the compressor is satisfied based on an ambient temperature being higher than a predetermined temperature and the A/C switch of the air conditioning device being in a closed state after starting the vehicle.

According to various aspects of the present disclosure, the controller may be further configured to: determine that the delayed operation condition of the compressor is satisfied based on an elapsed time after starting the vehicle not being greater than a first predetermined time period, a vehicle speed being slower than a predetermined vehicle speed, and a compressor rotation rate requested by the battery being slower than a first compressor rotation rate, and control the compressor not to operate within the first predetermined time period after starting the vehicle based on the delayed operation condition of the compressor being satisfied.

According to various aspects of the present disclosure, the controller may be further configured to: determine whether the compressor rotation rate requested by the battery is faster than a second compressor rotation rate based on the compressor not satisfying the delayed operation condition, and determine that the battery cooling condition is satisfied based on the compressor rotation rate requested by the battery being faster than the second compressor rotation rate.

According to various aspects of the present disclosure, the controller may be further configured to: determine whether the A/C switch of the air conditioning device is in the opened state based on the battery cooling condition not being satisfied.

According to various aspects of the present disclosure, the controller may be further configured to: determine expansion valve opening noise based on a pressure difference of the refrigerant between an upstream and a downstream of the expansion valve while the compressor has stopped the operation thereof; determine vehicle operating noise; and determine that the compressor satisfies the operation restoring condition based on the expansion valve opening noise being less than the vehicle operating noise.

According to various aspects of the present disclosure, the controller may be further configured to: determine whether a time elapsed after the compressor has stopped the operation is greater than a second predetermined time period based on the expansion valve opening noise being greater than or equal to vehicle operating noise; and open the expansion valve and control the compressor to restore the operation based on the time elapsed after the compressor has stopped the operation being greater than the second predetermined time period.

According to various aspects of the present disclosure, the present disclosure provides a method for controlling a heat management system for a vehicle. The method may include: determining whether a delayed operation condition of a compressor is satisfied while the compressor is not operated; controlling an operation of the compressor to be delayed based on the determining that the delayed operation condition of the compressor is satisfied; determining whether a battery cooling condition is satisfied based on the determining that the delayed operation condition of the compressor is not satisfied; and controlling the compressor to be operated based on the determining that the battery cooling condition is satisfied.

According to various aspects of the present disclosure, the method may further include: determining whether an A/C switch of an air conditioning device is in an opened state while the compressor is operated; and controlling the compressor to stop the operation based on the A/C switch of the air conditioning device is in the opened state.

According to various aspects of the present disclosure, the method may further include: determining whether the compressor satisfies an operation restoring condition while the compressor has stopped the operation thereof; and opening the expansion valve and controlling the compressor to restore the operation based on the compressor satisfying the operation restoring condition.

According to various aspects of the present disclosure, the determining of whether a delayed operation condition of a compressor is satisfied may be performed based on an ambient temperature being higher than a predetermined temperature, and the A/C switch of the air conditioning device being in a closed state after starting the vehicle.

According to various aspects of the present disclosure, the method may further include: determining that the delayed operation condition of the compressor is satisfied based on an elapsed time after starting the vehicle not being greater than a first predetermined time period, a vehicle speed being slower than a predetermined vehicle speed, and a compressor rotation rate requested by the battery being slower than a first compressor rotation rate; and controlling the compressor not to operate within the first predetermined time period after starting the vehicle based on that the delayed operation condition of the compressor being satisfied.

According to various aspects of the present disclosure, the method may further include: determining whether the compressor rotation rate requested by the battery is faster than a second compressor rotation rate based on the compressor not satisfying the delayed operation condition; and determining that the battery cooling condition is satisfied based on the compressor rotation rate requested by the battery being faster than the second compressor rotation rate.

According to various aspects of the present disclosure, the method may further include: determining whether the A/C switch of the air conditioning device is in the opened state based on the battery cooling condition not being satisfied.

According to various aspects of the present disclosure, the method may further include: determining expansion valve opening noise based on a pressure difference of the refrigerant between an upstream and a downstream of the expansion valve while the compressor has stopped the operation thereof; determining vehicle operating noise; and determining that the compressor satisfies the operation restoring condition based on the expansion valve opening noise being less than the vehicle operating noise.

According to various aspects of the present disclosure, the method may further include: determining whether a time elapsed after the compressor has stopped the operation is greater than a second predetermined time period based on the expansion valve opening noise being greater than or equal to vehicle operating noise; and opening the expansion valve and controlling the compressor to restore the operation based on the time elapsed after the compressor has stopped the operation being greater than the second predetermined time period.

According to various aspects of the present disclosure, the compressor may be delayed in its operation, thereby avoiding stoppage of the operation of the compressor. When stoppage of the operation of the compressor is unavoidable, the time during which the stoppage of the operation of the compressor may be reduced. Hence, the battery cooling function of the electric vehicle may be guaranteed, and the cooling function inside the vehicle may be improved.

Effects that may be obtained or expected from embodiments of the present disclosure will be directly or suggestively described in the following detailed description. That is, various effects expected from embodiments of the present disclosure will be described in the following detailed description.

### BRIEF DESCRIPTION OF THE DRAWINGS

The purpose of the present disclosure, other purposes, features, and other merits will be more clearly understood through the detailed description presented below along with the drawings.

FIG. 1 shows a schematic diagram of a heat management system for a vehicle according to an exemplary embodiment of the present disclosure.

FIG. 2 shows a block diagram of a heat management system for a vehicle according to an exemplary embodiment of the present disclosure.

FIG. 3 shows a flowchart on a method for controlling a heat management system for a vehicle according to an exemplary embodiment of the present disclosure.

### DETAILED DESCRIPTION

The term “vehicle” or “vehicular” or other similar terms used in the present specification are understood to include vehicles, generally private automobiles including sports utility vehicles (SUVs), buses, trucks, various commercial vehicles, vessels including various boats and ships, aircraft, and the like, as well as hybrid vehicles, electric vehicles, plug-in hybrid electric vehicles, hydrogen-powered vehicles, and other alternative fuel vehicles (e.g., fuels derived from resources other than petroleum).

Although the exemplary embodiment of the present disclosure is described as using a plurality of units to perform the processes, it should be understood that the processes may be performed by one or a plurality of modules. The term controller/control unit should be understood to refer to a hardware device that includes a memory and a processor and is specifically programmed to execute the processes described in the present specification. The memory is configured to store modules, and the processor is configured to execute the modules to perform one or more processes, which are described below.

Any singular terms used in the present specification are intended to include plural forms as well, unless the context clearly indicates otherwise. These terms are intended to distinguish one component from another, and do not limit the characteristics, sequences, or order of the components. It will also be understood that the terms “comprise” and/or “comprising,” when used in the present specification, specify the presence of a specified feature, essence, step, operation, element and/or component, but that this does not preclude the presence or addition of one or more other features, essences, steps, operations, elements, components and/or groups thereof. The term “and/or” as used in the present specification includes any and all combinations of one or more of the associated listed items.

A heat management system for a vehicle, and a control method thereof according to an exemplary embodiment of the present disclosure will now be described with reference to accompanying drawings.

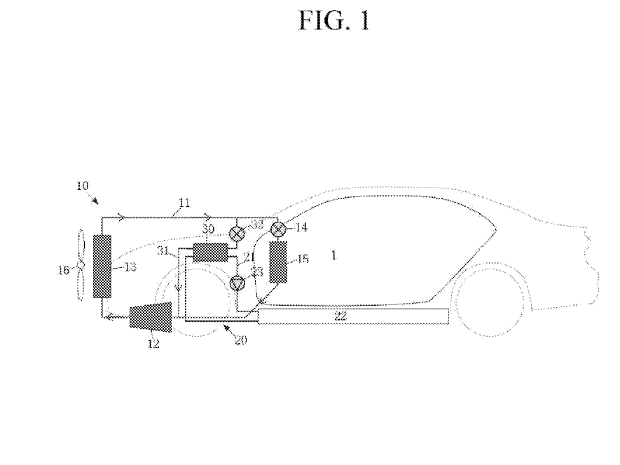

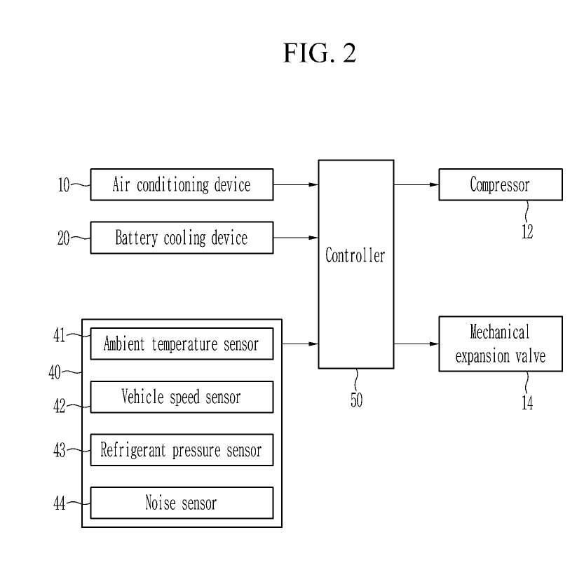

FIG. 1 shows a schematic diagram of a heat management system for a vehicle according to an exemplary embodiment of the present disclosure, and FIG. 2 shows a block diagram on a heat management system for a vehicle according to an exemplary embodiment of the present disclosure.

The heat management system for a vehicle may include an air conditioning device 10 and a battery cooling device 20.

As shown in FIG. 1, the air conditioning device 10 may include a refrigerant pipeline 11 through which a refrigerant is circulated, a compressor 12 disposed in the refrigerant pipeline 11, a condenser 13, a mechanical expansion valve 14, an evaporator 15, and a cooling fan 16. In the air conditioning device 10, the compressor 12 may compress the refrigerant into a high-temperature/high-pressure gaseous refrigerant, the condenser 13 may condense the high-temperature/high-pressure gaseous refrigerant into a low-temperature liquefied refrigerant by releasing heat, and the low-temperature liquefied refrigerant discharged from the condenser 13 may absorb heat in the evaporator 15 and may be evaporated into a gaseous refrigerant, and the gaseous refrigerant may return to the compressor 12. The cooling fan 16 may be used to remove heat from the condenser 13 of the air conditioning device 10, thereby helping the condenser 13 to condense the refrigerant.

The battery cooling device 20 may include a cooling pipeline 21 for circulating coolant, a battery 22 disposed in the cooling pipeline 21, and a pump 23 used for pumping and transporting the coolant. The battery cooling device 20 may cool the battery 22 using the battery chiller 30. The battery 22 may be a high-voltage battery, which is the power source of the electric vehicle.

The battery chiller 30 may be a water-cooled heat-exchanger in an evaporator type. The battery chiller 30 may be disposed between the cooling pipeline 21 and a refrigerant branch line 31 branched from the refrigerant pipeline 11, and may be configured to cool the coolant through heat-exchange between the coolant of the cooling pipeline 21 and the refrigerant supplied by the air conditioning device 10 so that the battery 22 may be cooled using the cooled coolant.

An electronic expansion valve 32 may be disposed in the refrigerant branch line 31 upstream of the battery chiller 30 so that the refrigerant may be selectively inflowed into the battery chiller 30.

As shown in FIG. 1, the battery chiller 30 may be disposed in parallel with the evaporator 15 so that the refrigerant flowing out of the condenser 13 may inflow into the battery chiller 30 and the evaporator 15 through the refrigerant branch line 31 and the refrigerant pipeline 11, respectively.

In the battery cooling mode, the refrigerant may be compressed by operation of the compressor 12, and the battery chiller 30 may cool the coolant through heat-exchange between the refrigerant and the coolant, and may cool the battery 22 using the cooled coolant. The A/C switch of the air conditioning device may be in the closed state, and the mechanical expansion valve 14 disposed on the upstream portion of the evaporator 15 may be closed so that a pressure difference of the refrigerant occurs between the upstream portion and the downstream portion of the mechanical expansion valve 14.

As shown in FIG. 2, the heat management system for a vehicle according to an exemplary embodiment of the present disclosure may further include a sensor unit 40 and a controller 50.

The sensor unit 40 may include an ambient temperature sensor 41, a vehicle speed sensor 42, a refrigerant pressure sensor 43, and a noise sensor 44. The ambient temperature sensor 41 may be used to measure ambient temperatures. The vehicle speed sensor 42 may be used to measure vehicle speeds. The refrigerant pressure sensor 43 may include pressure sensors disposed on upstream and downstream portions of the mechanical expansion valve 14, respectively, and may measure the refrigerant pressure of the upstream and downstream portions of the mechanical expansion valve 14. The noise sensor 44 may be used to measure vehicle operating noise.

The controller 50 may receive information measured by respective sensors of the sensor unit 40 by communicating with the sensor unit 40 through vehicle-mounted communication (e.g., CAN communication). The controller 50 may receive various information for controlling the heat management system of the vehicle by communicating with other components disposed in the vehicle through vehicle-mounted communication. For example, the controller 50 may be configured to receive a vehicle starting signal from a vehicle control unit (VCU), receive status information on an A/C switch from the air conditioning device 10, and receive a compressor rotating rate requested by the battery from the battery cooling device 20.

In detail, upon starting the vehicle, the controller 50 may be configured to receive the vehicle starting signal from the vehicle control unit to determine whether the vehicle has started and determine the starting time of vehicle. When the vehicle is determined to have started, the controller 50 may be configured to receive an ambient temperature (T_{amb}) from the ambient temperature sensor 41 of the sensor unit 40 and determine whether the ambient temperature (T_{amb}) is higher than a predetermined temperature (T₁).

When the ambient temperature is comparatively low, a cooling load of the air conditioning device 10 is comparatively small, and the stoppage of the operation of the compressor has a comparatively small effect on the cooling effect inside the vehicle. When the ambient temperature is comparatively high, the cooling load of the air conditioning device 10 is comparatively large, and the stoppage of the operation of the compressor has a comparatively large effect on the cooling effect inside the vehicle. Therefore, when the ambient temperature is comparatively high, the compressor should be prevented from stopping the operation as much as possible, or if the compressor cannot be prevented from stopping the operation, the duration of stopping the operation of the compressor must be shortened as much as possible.

In detail, when the ambient temperature (T_{amb}) is determined to be higher than the predetermined temperature (T₁), the controller 50 may be configured to receive status information of the A/C switch from the air conditioning device 10 and determine whether the A/C switch is in the opened state. For example, the predetermined temperature (T₁) may be 30°C.

When the A/C switch is determined to be in the opened state, the controller 50 may be configured to open the mechanical expansion valve 14 and control the start of the operation of the compressor 12. In the instant case, the mechanical expansion valve 14 is opened before performing the battery cooling mode, so expansion valve opening noise does not occur.

By determining as that the A/C switch is in the closed state, the controller 50 may be configured to determine whether the delayed operation condition of the compressor is satisfied. In an exemplary embodiment of the present disclosure, when satisfying the delayed operation condition of the compressor, if there is a cooling demand for the battery 22, the compressor 12 does not operate immediately, but starts an operation after a predetermined time delay. When the user opens the A/C switch of the air conditioning device during the compressor delay operation period, the controller 50 may open the mechanical expansion valve 14 and may be configured for controlling the compressor to start an operation. In the instant case, the mechanical expansion valve 14 opens before performing the battery cooling mode, so expansion valve opening noise does not occur. Therefore, according to the vehicle heat management system, the stoppage of the operation of the compressor may be avoided as much as possible by delaying the operation of the compressor.

In an exemplary embodiment of the present disclosure, the delayed operation condition of the compressors may include a time elapsed after starting the vehicle, a vehicle speed, and a compressor rotation rate required by the battery.

In detail, the controller 50 may be configured to determine the time (tₛₜₐᵣₜ) elapsed after starting the vehicle based on the vehicle starting point, and to determine whether the time (tₛₜₐᵣₜ) elapsed after starting the vehicle exceeds the first predetermined time period (t₁). When the time elapsed after starting the vehicle is comparatively long, the battery cooling load is comparatively large, and compressor delay operation is detrimental to cooling the battery. Therefore, when the time elapsed after starting the vehicle is comparatively long, the battery delay operation is not performed to ensure the battery cooling effect.

The controller 50 may be configured to receive a vehicle speed (Vₛ) from the vehicle speed sensor 42 of the sensor unit 40 and determine whether the vehicle speed (Vₛ) is slower than a predetermined vehicle speed (V₁). When the vehicle speed is comparatively slow, the driving load of the vehicle is comparatively small, and an amount of heat generated by the battery 22 is comparatively small so that the temperature of battery 22 does not increase rapidly. Therefore, when the vehicle speed is comparatively slow, and the compressor 12 may not operate immediately, an impact on the battery cooling effect is comparatively small, so that the compressor may be delayed in operation.

Conversely, when the vehicle speed is comparatively fast, the vehicle driving load is comparatively large, and the amount of heat generated by the battery 22 is comparatively large so that the temperature of battery 22 increases rapidly. Therefore, to ensure the battery cooling effect, the delay operation of the compressor is not performed.

The controller 50 may be configured to receive a compressor rotation rate (R_{batreq}) requested by the battery from the battery cooling device 20 and determine whether the compressor rotation rate (R_{batreq}) requested by the battery is slower than the first compressor rotation rate (R₁). The compressor rotation rate (R_{batreq}) requested by the battery refers to the compressor rotation rate required for cooling the battery.

When the compressor rotation rate requested by the battery is comparatively low, it means that the battery cooling load is comparatively small. Therefore, when the compressor rotation rate requested by the battery is comparatively low, and the compressor 12 does not operate immediately, the impact on the battery cooling effect is comparatively small so that the battery delay operation may be performed.

Conversely, when the compressor rotation rate requested by the battery is comparatively high, it means that the battery cooling load is comparatively large. Therefore, when the compressor rotation rate requested by the battery is comparatively high, the compressor delay operation is not performed to ensure the battery cooling effect.

In detail, when the time elapsed after starting the vehicle (tₛₜₐᵣₜ) does not exceed the first predetermined time period (t₁), the vehicle speed (Vₛ) is slower than the predetermined vehicle speed (V₁), and the compressor rotation rate (R_{batreq}) requested by the battery is slower than the first compressor rotation rate (R₁), the controller 50 may be configured to determine that the delayed operation condition of the compressor is satisfied and perform the compressor delay operation. Otherwise, the controller 50 may be configured to determine as that the delayed operation condition of the compressor is not satisfied. For example, the first predetermined time period (t₁) may be 180s, the predetermined vehicle speed (V₁) may be 25kph, and the first compressor rotation rate (R₁) may be 4000rpm.

When it is determined as that the delayed operation condition of the compressor is satisfied, the controller 50 may be configured to control the compressor 12 not to be operated within the first predetermined time period (t₁) after the vehicle starts, and to receive status information of the A/C switch from the air conditioning device 10 during the delay operation period of the compressor 12 to determine whether the status of the A/C switch is in the opened state. When the user opens the A/C switch of the air conditioning device during the delay operation period of the compressor 12, the controller 50 may be configured to open the mechanical expansion valve 14 and control the compressor to operate.

When it is determined as that the delayed operation condition of the compressor is not satisfied, the controller 50 may be configured to determine whether the battery cooling condition is satisfied.

In an exemplary embodiment of the present disclosure, when it is determined as that the battery cooling condition is satisfied, it means that there is a demand for cooling the battery 22 and the compressor 12 must be immediately operated.

In detail, the controller 50 is configured to receive a compressor rotation rate (R_{batreq}) requested by the battery from the battery cooling device 20 and determine whether the compressor rotation rate (R_{batreq}) requested by the battery is faster than a second compressor rotation rate (R₂).

In one aspect, when it is determined as that the compressor rotation rate (R_{batreq}) requested by the battery is not faster than the second compressor rotation rate (R₂) (i.e., there is no need to cooling the battery), the controller 50 may be configured to determine as that the battery cooling condition is not satisfied, and receive status information of the A/C switch from the air conditioning device 10 to determine whether the A/C switch is in the open state. For example, the second compressor rotation rate (R₂) may be 0 rpm.

When the battery cooling condition is not satisfied, and the A/C switch of the air conditioning device is determined to be in the opened state, the controller 50 may be configured to open the mechanical expansion valve 14 and control the compressor 12 to start an operation. In the instant case, the mechanical expansion valve 14 is opened before the battery cooling mode is executed so expansion valve opening noise does not occur. However, the vehicle heat management system may avoid the occurrence of the stoppage of the operation of the compressor as much as possible by delaying the operation of the compressor.

Conversely, when the battery cooling condition is not satisfied, and the A/C switch of the air conditioning device is determined to be in the closed state, the controller 50 may be configured to determine whether the battery cooling condition is satisfied.

In another aspect, when the compressor rotation rate (R_{batreq}) requested by the battery is faster than the second compressor rotation rate (R₂), the controller 50 may be configured to determine as that the battery cooling condition is satisfied, and control the compressor 12 to start an operation. During the period of operating the compressor 12, the controller 50 may be configured to receive status information of the A/C switch from the air conditioning device 10 and determine whether the A/C switch is in the opened state.

When the battery cooling condition is satisfied, the compressor 12 is operating, and the A/C switch of the air conditioning device is determined to be in the opened state, the controller 50 may be configured to control the compressor 12 to stop the operation. When the compressor has stopped its operation, the controller 50 may be configured to determine whether the compressor operation restoring condition is satisfied.

In an exemplary embodiment of the present disclosure, satisfying of the compressor operation restoring condition may represent that the compressor 12 may recover the operation while the operation is stopped.

In detail, the controller 50 may be configured to receive the refrigerant pressure (P1) of the upstream portion of the mechanical expansion valve 14 and the refrigerant pressure (P2) of the downstream portion from the refrigerant pressure sensor 43 of the sensor unit 40. The controller 50 may be configured to determine the expansion valve opening noise (Nₛₒᵥ) generated when opening the mechanical expansion valve 14 based on the pressure difference (△P=P1-P2) of the refrigerant between the upstream and downstream portions of the mechanical expansion valve 14.

The controller 50 may be configured to receive vehicle operating noise (Nᵥₑₕ) from the noise sensor 44 of the sensor unit 40. For example, the vehicle operating noise may include tire noise, road noise, wind noise, and noise generated when each component disposed in the vehicle operates. The controller 50 may be configured to determine whether the expansion valve opening noise (Nₛₒᵥ) is less than the vehicle operating noise (Nᵥₑₕ).

When the expansion valve opening noise (Nₛₒᵥ) is smaller than the vehicle operating noise (Nᵥₑₕ), and noise occurs when the mechanical expansion valve 14 is opened, the noise may be covered by the vehicle operating noise. In the instant case, the compressor 12 may recover the operation from the operation stopped state. Therefore, when the expansion valve opening noise (Nₛₒᵥ) is less than the vehicle operating noise (Nᵥₑₕ), the controller 50 may be configured to determine that the compressor operation restoring condition is satisfied.

In one aspect, when it is determined that the compressor operation restoring condition is satisfied, the controller 50 may be configured to open the mechanical expansion valve 14 and control the compressor 12 to restore operation.

Conventional air conditioning devices cause the compressor to stop operating for a fixed time. To ensure that the pressure difference of the refrigerant between the upstream and downstream portions of the mechanical expansion valve 14 is reduced to an acceptable level, the fixed time may be generally set to be comparatively long, which is detrimental to both cooling the battery and cooling the interior of the vehicle.

However, the vehicle heat management system according to the exemplary embodiment of the present disclosure may be configured for controlling the compressor to recover the operation when the compressor operation restoring condition is satisfied, and there is no need to wait until the refrigerant pressure difference between the upstream and downstream portions of the mechanical expansion valve 14 is reduced to an acceptable level. Accordingly, the vehicle heat management system may reduce the time during which the compressor operation stoppage continues when the compressor operation stoppage may not be avoided.

In another aspect, when it is determined as that the compressor operation restoring condition is not satisfied, the controller 50 may be configured to determine whether the time (t_{off}) elapsed when the compressor stopped the operation is greater than a second predetermined time period (t₂). The second predetermined time period (t₂) may represent that the elapsed time (t_{off}) when the compressor has stopped the operation is sufficient for the pressure difference (△P) of the refrigerant between the upstream and downstream portions of the mechanical expansion valve 14 to decrease to an acceptable level. The second predetermined time period (t₂) may be 180s.

In detail, when the elapsed time (t_{off}) after the compressor has stopped the operation is greater than the second predetermined time period (t₂), the controller 50 may be configured to open the mechanical expansion valve 14 and control the compressor 12 to resume the operation. Conversely, when the elapsed time (t_{off}) after the compressor has stopped the operation is not greater than the second predetermined time period (t₂), the controller 50 may be configured to re-determine whether the compressor operation restoring condition is satisfied.

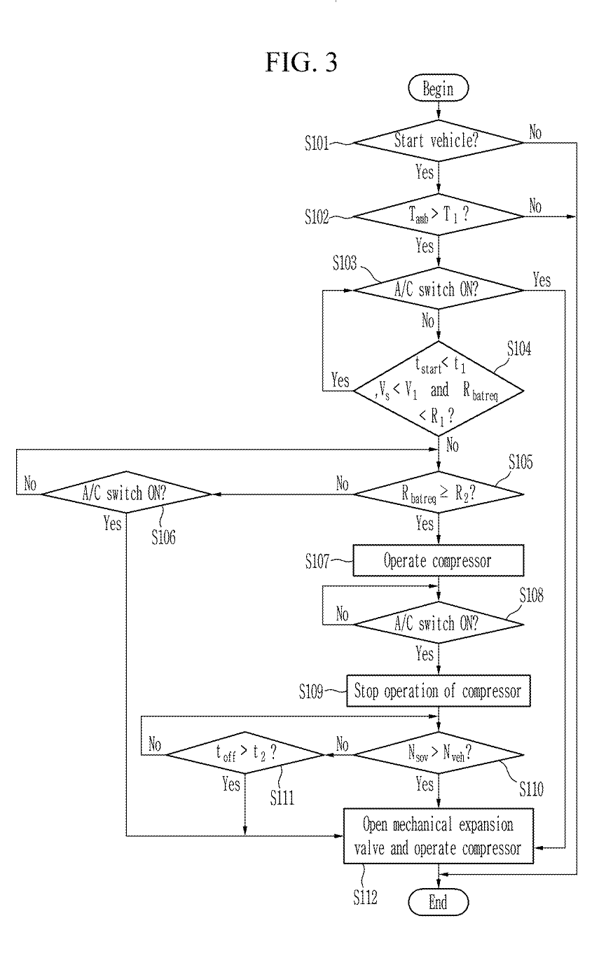

FIG. 3 shows a flowchart on a method for controlling a heat management system for a vehicle according to an exemplary embodiment of the present disclosure. A control method including S101 to S112 will now be described using the vehicle heat management system illustrated in FIG. 1 and FIG. 2.

As shown in FIG. 3, the controller 50 may receive a vehicle starting signal from the entire vehicle sensors, and may be configured to determine whether the vehicle is starting and the vehicle starting time (S101).

When it is determined that the vehicle has started (Yes in S101), the controller 50 may receive an ambient temperature (T_{amb}) from the ambient temperature sensor 41 and may be configured to determine whether the ambient temperature (T_{amb}) is higher than a predetermined temperature (T₁) (S102). For example, the predetermined temperature (T₁) may be 30°C.

When it is determined that the ambient temperature (T_{amb}) is higher than the predetermined temperature (T₁) (Yes in S102), the controller 50 may receive status information of the A/C switch from the air conditioning device 10 and may be configured to determine whether the A/C switch is in the opened state (S103). When it is determined that the A/C switch is in the opened state (Yes in S103), the controller 50 may open the mechanical expansion valve 14 and may be configured for controlling the compressor 12 to start an operation (S112).

In another aspect, when it is determined that the A/C switch is in the closed state (No in S103), the controller 50 may be configured to determine whether the compressor satisfies the delayed operation condition (S104).

In detail, the controller 50 may be configured to determine the time (tₛₜₐᵣₜ) elapsed after having started the vehicle based on the vehicle starting time, and may be configured to determine whether the time (tₛₜₐᵣₜ) elapsed after having started the vehicle is greater than the first predetermined time period (t₁). The controller 50 may receive the vehicle speed (Vₛ) from the vehicle speed sensor 42 and may be configured to determine whether the vehicle speed (Vₛ) is slower than a predetermined vehicle speed (V₁). The controller 50 may receive the compressor rotation rate (R_{batreq}) requested by the battery from the battery cooling device 20 and may be configured to determine whether the compressor rotation rate (R_{batreq}) requested by the battery is slower than the first compressor rotation rate (R₁). For example, the first predetermined time period (t₁) may be 180s, the predetermined vehicle speed (V₁) may be 25kph, and the first compressor rotation rate (R₁) may be 4000rpm.

When the time (tₛₜₐᵣₜ) elapsed after having started the vehicle is not greater than the first predetermined time period (t₁), the vehicle speed (Vₛ) is slower than the predetermined vehicle speed (V₁), and the compressor rotation rate (R_{batreq}) requested by the battery is slower than the first compressor rotation rate (R₁), the controller 50 may be configured to determine that the delayed operation condition of the compressor is satisfied.

When it is determined that the delayed operation condition of the compressor is satisfied (Yes in S104), the controller 50 may be configured for controlling the compressor 12 not to be operated within the first predetermined time period (t1) after the vehicle starts, and may return to S103 to determine again whether the A/C switch is in the opened state.

In another aspect, when it is determined that the delayed operation condition of the compressor is not satisfied (No in S104), the controller 50 may be configured to determine whether the battery cooling condition is satisfied (S105).

In detail, the controller 50 may receive the compressor rotation rate (R_{batreq}) requested by the battery from the battery cooling device 20 and may be configured to determine whether the compressor rotation rate (R_{batreq}) requested by the battery is faster than the second compressor rotation rate (R₂). When it is determined that the compressor rotation rate (R_{batreq}) requested by the battery is faster than the second compressor rotation rate (R₂), the controller 50 may be configured to determine as that the battery cooling condition is satisfied.

When it is determined that the battery cooling condition is satisfied (Yes in S105), the controller 50 may be configured for controlling the compressor 12 to start an operation (S107). For example, the second compressor rotation rate (R₂) may be 0 rpm.

In another aspect, when it is determined that the battery cooling condition is not satisfied (No in S105), in step S106, the controller 50 may receive status information of the A/C switch from the air conditioning device 10 and may be configured to determine whether the A/C switch is in the opened state. When the A/C switch is determined to be in the opened state (Yes in S106), the controller 50 may open the mechanical expansion valve 14 and may be configured for controlling the compressor to start an operation (S112). When it is determined that the A/C switch is in the closed state (No in S106), the process may return to S105 and may be configured to determine again whether the battery cooling condition is satisfied.

When it is determined that the battery cooling condition is satisfied and the compressor is operated, the controller 50 may receive status information of the A/C switch from the air conditioning device 10 and may be configured to determine whether the A/C switch is in the open state (S108). When it is determined that the A/C switch is in the closed state (No in S108), the S108 may be repeatedly performed to standby for the user to open the A/C switch of the air conditioning device.

In another aspect, when it is determined that the A/C switch is in the opened state (Yes in S108), the controller 50 may be configured for controlling the compressor to stop the operation (S109).

While the compressor has stopped the operation, the controller 50 may be configured to determine whether the compressor satisfies the operation restoring condition (S110).

In detail, the controller 50 may receive the refrigerant pressure P1 of the upstream portion of the mechanical expansion valve 14 and the refrigerant pressure P2 of the downstream portion thereof from the refrigerant pressure sensor 43. The controller 50 may be configured to determine the expansion valve opening noise (Nₛₒᵥ) generated when opening the mechanical expansion valve 14, based on the refrigerant pressure difference △P (△P=P1-P2) between the upstream and downstream portions of the mechanical expansion valve 14. The controller 50 may receive vehicle operating noise (Nᵥₑₕ) from the noise sensor 44.

The controller 50 may be configured to determine whether the expansion valve opening noise (Nₛₒᵥ) is less than the vehicle operating noise (Nᵥₑₕ).

When the expansion valve opening noise (Nₛₒᵥ) is less than the vehicle operating noise (Nᵥₑₕ), the controller 50 may be configured to determine as that the compressor operation restoring condition is satisfied. When it is determined as that the compressor operation restoring condition is satisfied (Yes in S110), the controller 50 may open the mechanical expansion valve 14 and may be configured for controlling the compressor 12 to recover the operation from the operation stopped state (S112).

In another aspect, when it is determined that the compressor operation restoring condition is not satisfied (NO in S110), the controller 50 may be configured to determine whether the elapsed time (t_{off}) after the compressor has stopped the operation is greater than the second predetermined time period (t₂) (S111). When the time (t_{off}) elapsed after the compressor has stopped the operation is greater than the second predetermined time period (t₂) (Yes in S111), the controller 50 may open the mechanical expansion valve 14 and may be configured for controlling the compressor 12 to recover the operation from the operation stop state (S112). For example, the second predetermined time period (t₂) is 180s.

When it is determined that the time (t_{off}) elapsed after the compressor has stopped the operation is not greater than the second predetermined time period (t₂) (NO in S111), it is possible to return to S110 and determine again whether the compressor operation restoring condition is satisfied.

The heat management system for a vehicle and the control method thereof according to an exemplary embodiment of the present disclosure may prevent the situation in which the operation of the compressor is stopped as much as possible by delaying the operation of the compressor. The heat management system for a vehicle and the control method thereof according to an exemplary embodiment of the present disclosure may shorten the time during which stopping of the operation of the compressor maintains when it is unavoidable to stop the operation of the compressor. Accordingly, the vehicle heat management system and the control method thereof according to the exemplary embodiment of the present disclosure may improve the internal cooling function of the vehicle while ensuring the battery cooling function of the electric vehicle.

While the present disclosure has been described in connection with what is presently considered to be practical embodiments, it is to be understood that the present disclosure is not limited to the disclosed exemplary embodiments of the present disclosure. On the other hand, it is directed to cover various modifications and equivalent claims as well as various alternatives and modifications thereof. It is intended that the scope of the present disclosure be defined by the Claims appended hereto and their equivalents.

What is claimed is:

1. A heat management system for a vehicle, the system comprising:
an evaporator disposed in an air conditioning device;
an expansion valve disposed on an upstream of the evaporator;
a battery chiller disposed in parallel with the evaporator, cooling a coolant by heat-exchange between the coolant and a refrigerant supplied from the air conditioning device, and cooling a battery using the cooled coolant;
a compressor compressing the refrigerant; and
a controller:
determining whether a delayed operation condition of the compressor is satisfied while the compressor is not operated,
controlling the compressor to delay operation thereof based on determining that the delayed operation condition of the compressor is satisfied,
determining whether a battery cooling condition is satisfied based on the determining that the delayed operation condition of the compressor is not satisfied, and
controlling the compressor to be operated based on the determining that the battery cooling condition is satisfied.

2. The heat management system of claim 1, wherein the controller:
determines whether an air conditioning (A/C) switch of an air conditioning device is in an opened state while the compressor is operated, and
controls the compressor to stop the operation based on the A/C switch of the air conditioning device being in the opened state.

3. The heat management system of claim 1, wherein the controller:
determines whether the compressor satisfies an operation restoring condition while the compressor has stopped the operation, and
opens the expansion valve and controls the compressor to restore the operation based on that the compressor satisfies the operation restoring condition.

4. The heat management system of claim 1, wherein the controller:
determines whether the delayed operation condition of the compressor is satisfied based on an ambient temperature being higher than a predetermined temperature and an A/C switch of the air conditioning device being in a closed state after starting the vehicle.

5. The heat management system of claim 1, wherein the controller:
determines that the delayed operation condition of the compressor is satisfied based on an elapsed time after starting the vehicle not being greater than a first predetermined time period, a vehicle speed being slower than a predetermined vehicle speed, and a compressor rotation rate requested by the battery being slower than a first compressor rotation rate, and
controls the compressor not to operate within the first predetermined time period after starting the vehicle based on the delayed operation condition of the compressor being satisfied.

6. The heat management system of claim 5, wherein the controller:
determine whether the compressor rotation rate requested by the battery is faster than a second compressor rotation rate based on the compressor not satisfying the delayed operation condition, and
determine that the battery cooling condition is satisfied based on the compressor rotation rate requested by the battery being faster than the second compressor rotation rate.

7. The heat management system of claim 6, wherein the controller determines whether an A/C switch of the air conditioning device is in an opened state based on the battery cooling condition not being satisfied.

8. The heat management system of claim 3, wherein the controller:
determines expansion valve opening noise based on a pressure difference of the refrigerant between the upstream and a downstream of the expansion valve while the compressor has stopped the operation thereof;
determines vehicle operating noise; and
determines that the compressor satisfies the operation restoring condition based on the expansion valve opening noise being less than the vehicle operating noise.

9. The heat management system of claim 8, wherein the controller:
determines whether a time elapsed after the compressor has stopped the operation is greater than a second predetermined time period based on the expansion valve opening noise being greater than or equal to the vehicle operating noise; and
opens the expansion valve and controls the compressor to restore the operation based on the time elapsed after the compressor has stopped the operation being greater than the second predetermined time period.

10. A method for controlling a heat management system for a vehicle, the method comprising:
determining, by a controller, whether a delayed operation condition of a compressor is satisfied while the compressor is not operated;
controlling, by the controller, an operation of the compressor to be delayed based on determining that the delayed operation condition of the compressor is satisfied;
determining, by the controller, whether a battery cooling condition is satisfied based on the determining that the delayed operation condition of the compressor is not satisfied; and
controlling, by the controller, the compressor to be operated based on the determining that the battery cooling condition is satisfied.

11. The method of claim 10, further comprising:
determining, by the controller, whether an air conditioning (A/C) switch of an air conditioning device is in an opened state while the compressor is operated; and
controlling, by the controller, the compressor to stop the operation based on the A/C switch of the air conditioning device is in the opened state.

12. The method of claim 11, further comprising:
determining, by the controller, whether the compressor satisfies an operation restoring condition while the compressor has stopped the operation thereof; and
opening, by the controller, an expansion valve and controlling, by the controller, the compressor to restore the operation based on the compressor satisfying the operation restoring condition.

13. The method of claim 10, wherein the determining of whether the delayed operation condition of the compressor is satisfied is performed based on an ambient temperature being higher than a predetermined temperature, and an A/C switch of an air conditioning device being in a closed state after starting the vehicle.

14. The method of claim 10, further comprising:
determining, by the controller, that the delayed operation condition of the compressor is satisfied based on an elapsed time after starting the vehicle not being greater than a first predetermined time period, a vehicle speed being slower than a predetermined vehicle speed, and a compressor rotation rate requested by a battery being slower than a first compressor rotation rate; and
controlling, by the controller, the compressor not to operate within the first predetermined time period after starting the vehicle based on that the delayed operation condition of the compressor being satisfied.

15. The method claim 14, further comprising:
determining, by the controller, whether the compressor rotation rate requested by the battery is faster than a second compressor rotation rate based on the compressor not satisfying the delayed operation condition; and
determining, by the controller, that the battery cooling condition is satisfied based on the compressor rotation rate requested by the battery being faster than the second compressor rotation rate.

16. The method of claim 15, further comprising:
determining, by the controller, whether an A/C switch of an air conditioning device is in an opened state based on the battery cooling condition not being satisfied.

17. The method of claim 12, further comprising:
determining, by the controller, expansion valve opening noise based on a pressure difference of a refrigerant between an upstream and a downstream of the expansion valve while the compressor has stopped the operation thereof;
determining, by the controller, vehicle operating noise; and
determining, by the controller, that the compressor satisfies the operation restoring condition based on the expansion valve opening noise being less than the vehicle operating noise.

18. The method of claim 17, further comprising:
determining, by the controller, whether a time elapsed after the compressor has stopped the operation is greater than a second predetermined time period based on the expansion valve opening noise being greater than or equal to the vehicle operating noise; and
opening, by the controller, the expansion valve and controlling the compressor to restore the operation based on the time elapsed after the compressor has stopped the operation being greater than the second predetermined time period.
